(19) United States
(12) Patent Application Publication
(10) Pub. No.: US 2024/0007698 A1
(43) Pub. Date: Jan. 4, 2024

(54) SYSTEM AND METHOD FOR GENERATING A VOICE PROMPT IN RESPONSE TO REMOTE CONTROL ACTUATION

(71) Applicant: ARRIS ENTERPRISES LLC, Suwanee, GA (US)

(72) Inventors: Yong LIANG, Shanghai (CN); Xiang SHEN, Shanghai (CN); Xuewei ZHAO, Shanghai (CN); Qi WANG, Shanghai (CN)

(73) Assignee: ARRIS ENTERPRISES LLC, Suwanee, GA (US)

(21) Appl. No.: 18/019,511

(22) PCT Filed: Aug. 13, 2020
(86) PCT No.: PCT/CN2020/108818

§ 371 Date: Feb. 3, 2023

(51) Int. Cl. H04N 21/422; H04N 21/472

(52) U.S. Cl. CPC H04N 21/42222; H04N 21/472

(57) ABSTRACT

A system and method for generating an audio prompt in response to the actuation of a button on a remote-control button. This audio prompt provides aural feedback to a user that may impaired from discerning the functionality of buttons upon a remote control. This impairment may be environmental (poor lighting) or a consequence of the physical condition of the user (poor eyesight). A particular embodiment of the system and method enables audio feedback to be generated prior to the execution of any command associated with an actuated button, thereby permitting a user to take corrective action if the button was actuated inadvertently.

### BACKGROUND OF THE INVENTION

It is a common practice for designers of consumer electronics to minimize the number of controls or buttons on a given appliance. This design practice results in what many consider to be sleeker and cleaner product designs and, in many cases, result in a product that is less costly to manufacture and more resistant to mechanical failure. However, this design practice usually mandates that a multi-buttoned remote control be employed by a user to control and interface with the appliance.

This minimalist design practice and the associated need for a user to utilize a remote control are readily evident with respect to both digital televisions and the set-top boxes that typically serve as media gateways to broadband content providers. The face of hand-held remote controls for such systems typically have a significant number of relatively small buttons, each labeled with an alphanumeric character or function. Given the minimal size of the buttons and the associated labels, it can be difficult for a person with normal vision to read the button labels in low-light situations. Individuals with impaired vision might find it impossible to recognize or read such button labels regardless of the lighting conditions.

It would therefore be desirable to provide a system and method for providing audible prompts indicative of the functionality and labeling of remote hand-held remote-control buttons. Ideally such audible prompts should be generated by the appliance being controlled so as to provide the user with a seamless media experience.

### BRIEF SUMMARY OF THE INVENTION

A system and method for generating an audio prompt in response to the actuation of a button on a remote-control button. This audio prompt provides aural feedback to a user that may impaired from discerning the functionality of buttons upon a remote control. This impairment may be environmental (poor lighting) or a consequence of the physical condition of the user (poor eyesight). A particular embodiment of the system and method enables audio feedback to be generated prior to the execution of any command associated with an actuated button, thereby permitting a user to take corrective action if the button was actuated inadvertently.

### BRIEF DESCRIPTION OF THE DRAWINGS

The aspects, and advantages of the present invention will become better understood with regard to the following description, appended claims, and accompanying drawings in which:

FIG. 1 is a is a functional block diagram of a preferred embodiment of a system generating voice prompts in response to the actuation of a remote-control.

FIG. 2A is a side-view depicting unactuated buttons upon a remote-control in accordance with a particular embodiment.

FIG. 2B is a side-view depicting partially-actuated buttons upon a remote-control in accordance with a particular embodiment.

FIG. 2C is a side-view depicting fully-actuated buttons upon a remote-control in accordance with a particular embodiment.

### DETAILED DESCRIPTION

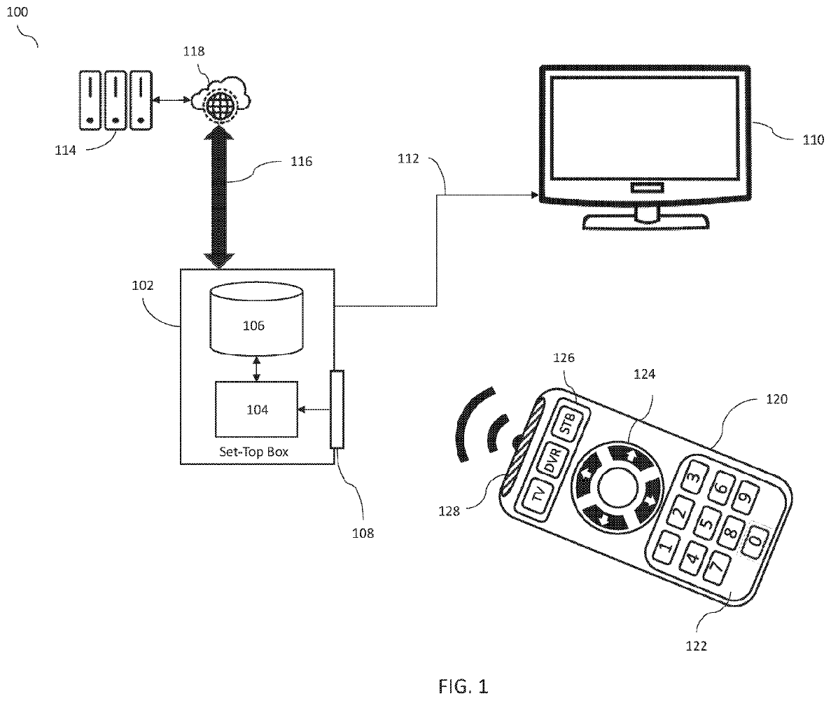

FIG. 1 is a functional diagram of a preferred embodiment of a system (100) adapted to provide audible cues in response to the actuation of remote-control buttons. As shown, system 100 comprises set-top box (“STB”) 102, which includes processor 104, memory 106 and wireless receiver 108. STB 102 is also shown to be linked to digital television 110 (via HDMI cable 112) and to headend 114 (via broadband link 116 and network 118).

Also included in system 100 is hand-held remote-control 120. Hand-held remote control includes numeric buttons 122, directional control buttons 124, function control buttons 126 and wireless transmitter 128. Wireless transmitter 128 is adapted to transmit signals indicative of the actuation of a particular button to wireless receiver 108. This transmission can be a radio frequency transmission (Bluetooth®, 802.11 Wi-Fi, ZigBee, or a proprietary protocol) or via optical transmission (infrared). Processor 104 is adapted to recognize particular wireless signals received via wireless receiver 108 and associate each with the action of a user actuating a particular one of the buttons on remote control 120.

Memory 106 has stores audio data associated with each of the buttons upon remote control 120. This audio data is utilized by processor 102 to generate audible speech via the speaker or speakers associated with television 110. The audio data can data representing recorded speech or prompt, such as an mp3 file, or data representative of information that can be utilized by processor 104 to synthesize speech or an audible prompt. Table A below provides a mapping of the buttons on remote control 120 to the words or phrases that would be generated from the associated data within memory 106:

TABLE A

| Button | Word/Phrase |
|---|---|
| 0 | Zero |
| 1 | One |
| 2 | Two |
| 3 | Three |
| 4 | Four |
| 5 | Five |
| 6 | Six |
| 7 | Seven |
| 8 | Eight |
| 9 | Nine |
| TV | Television |
| DVR | Digital Video Recorder |
| STB | Set-Top Box |
| ↑ | Up |
| ↓ | Down |
| ← | Left |
| → | Right |

A user desiring to utilize remote control 120 to tune set-top box 102 to channel 56 would actuate the following buttons:
STB, 5, 6.

As each of these buttons was actuated, remote control 120 would generate and transmit an associated wireless signal to processor 104 (via wireless transmitter 128 and wireless receiver 108). Upon receipt of each of the transmitted signals, processor 104 would query memory 106 and retrieve audio data associated with the button that was actuated. This retrieved audio data would then be utilized to generate an audible prompt that would be played via the speaker or speakers associated with television 110. Currently available processors can perform audio processing very efficiently and with very little lag time, consequently each audible prompt can be generated in a manner that a user would perceive as being essentially concurrent with the actuation of the associated remote-control button. As the user actuated the STB, 5 and 6 buttons, the following audible prompts would be heard:
Set-Top Box
Five
Six
   This would provide the user with substantially immediate audio feedback as each of the three buttons were actuated. The user would be confident in knowing what buttons had been actuated and could take corrective measures if an unintended button was mistakenly actuated. The received wireless signals would also cause processor 102 to execute commands associated with the buttons that were actuated. In the above case, this would result in set-top box 102 being tuned to channel 56.

In an alternate embodiment, the buttons upon remote control 120 are each adapted to cause two distinct wireless signals to be transmitted by wireless transmitter 128. The first of these being generated when a given button is partially actuated. This first generated wireless signal instructs processor 104 to query memory 106 and retrieve audio data associated with the partially-actuated button. This retrieved audio data would then be utilized to generate an audible prompt that would be played via the speaker or speakers associated with television 110. Upon hearing the audible prompt, a user can then fully-actuate the button if it is indeed the button the user intended to actuate. When the button is fully actuated remote control 120 generates a second wireless signals which when received by set-top box 102 causes processor 104 to retrieve from memory 106 command data associated with the fully-actuated button and execute the retrieved command data.

If upon hearing the audible prompt generated in response to a partially-actuated button, the user realizes that they have pressed the wrong button—For example, the user meant to actuate the “5” button but heard the audible prompt “six”—the user can reposition their fingers accordingly and partially actuate the correct button. The unintentional partial actuation of the “6” button would not have caused processor 104 to execute command data directing set-top box 102 to do anything, as the “6” button was never fully actuated. The two-position button actuation (partially actuated/fully-actuated) permits a user to respond to the audible prompts and correct inadvertent button actuations prior to any command data being executed.

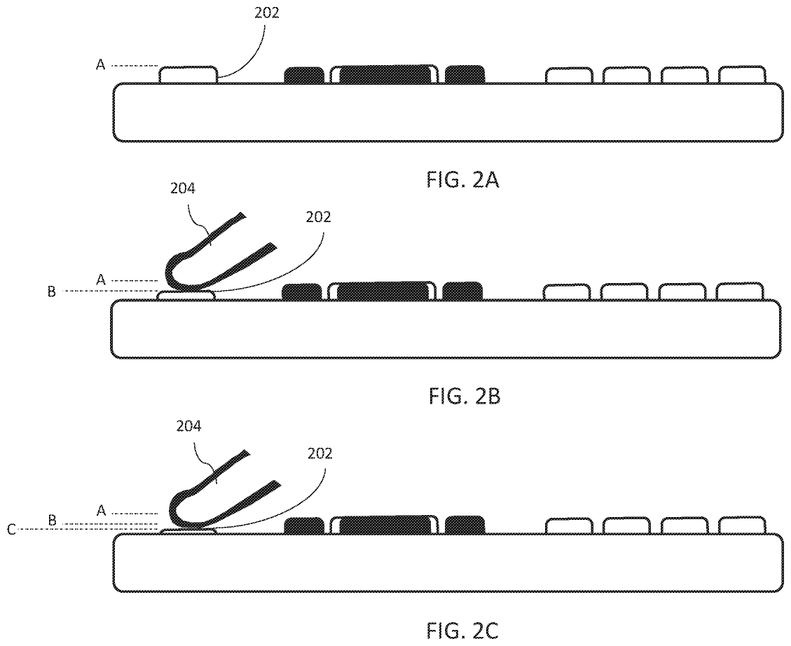

FIGS. 2A-C provide an illustration of the manner in which buttons upon remote control 120 can be partially and then fully actuated. As shown in FIG. 2A, button 202 (the “TV” button shown in FIG. 1) is unactuated and is biased upward in a fully undepressed state (indicated by dashed line A). A user then applies a moderate pressure using their finger (204) to button 202, thereby partially-actuating the button and depressing it to the position indicated by dashed line B. Finally, when the user applies increased pressure with their finger, button 202 is depressed into a fully actuated position (see dashed line C). The remote control can be adapted to provide tactile feedback to the user when the partially actuated position is reached. Such feedback arrangements are well-known in the art.

Processor 104 may be further adapted to mix the audio prompts with the present audio content being played over the speakers associated with television 110, or the processor could be configured to partially or fully mute the audio program so as to permit the audio prompt to be clearly heard by a user. The particular manner in which the audio prompt is played could be a function of the identity of the user, set by the user, pre-programmed into set-top box 120 by a multi-service operator, or set by programming received from headend 114 via network 118 and broadband link 116.

Memory 106 may also be adapted to store audio prompts in multiple languages. A user my choose the particular language they wish to hear the audio prompts provided in. The particular language could be a function of the identity of the user, set by the user, pre-programmed into set-top box 120 by a multi-service operator, or set by programming received from headend 114.

Although the invention herein has been described with reference to particular embodiments, it is to be understood that these embodiments are merely illustrative of the principles and applications of the present invention. For example, the functionality of the set-top box, or the processor and/or memory within the set-top box could be provided by remotely-located resources, such as remote servers located at the head-end, or at other networked locations (cloud services). In addition, the set-top box can be a stand-alone device, integrated into another system or device such as a television, a digital assistant, smartphone, tablet or a computer. The remote-control functionality could also be provided by a dedicated device, or implemented via an application executing on a smart device such as a phone, tablet or computer. without departing from the spirit and scope of the present invention as defined by the appended claims.

1. A system for generating an audible prompt in response to the actuation of a remote control, the system comprising:
at least one media gateway appliance, comprising at least one processor, at least one memory, and at least one wireless signal receiver, wherein the memory is adapted to store audio prompt data associated with at least one particular button upon a remote-control device; and
wherein the at least one processor is adapted to:
receive from the wireless signal receiver a signal indicative of the actuation of at least one button upon a remote-control device;
retrieve from the at least one memory audio prompt data associated with the at least one actuated button; and
generate an audio signal based, at least in part, on the retrieved audio prompt data.

2. The system of claim 1 wherein the media gateway appliance comprises at least one of the following:
a set-top box;
a television;
a computer;
a digital assistant;
smartphone; and
a tablet.

3. The system of claim 1 wherein the audio prompt data comprises at least one of the following:
a recording of speech;
a recording of a sound;
speech synthesis data; and
sound synthesis data.

4. The system of claim 1 wherein the generated audio signal drives a speaker associated with a television system.

5. The system of claim 1 wherein at least one of the processor and the memory are located remotely from the at least one media gateway appliance.

6. A system for generating an audible prompt in response to the actuation of a remote control, the system comprising:
at least one media gateway appliance, comprising at least one processor, at least one memory, and at least one wireless signal receiver, wherein the memory is adapted to store audio prompt data associated with at least one particular button upon a remote-control device; and
wherein the at least one processor is adapted to:
receive from the wireless signal receiver a first signal indicative of the partial actuation of at least one button upon a remote-control device;
retrieve from the at least one memory audio prompt data associated with the at least one partially actuated button;
generate an audio signal based, at least in part, on the retrieved audio prompt data;
receive from the wireless signal receiver a second signal indicative of the full actuation of the at least one button upon a remote-control device;
retrieve from the at least one memory command data associated with the at least one fully-actuated button; and
execute the retrieved command data.

7. The system of claim 6 wherein the media gateway appliance comprises at least one of the following:
a set-top box;
a television;
a computer;
a digital assistant;
smartphone; and
a tablet.

8. The system of claim 6 wherein the audio prompt data comprises at least one of the following:
a recording of speech;
a recording of a sound;
speech synthesis data; and
sound synthesis data.

9. The system of claim 6 wherein the generated audio signal drives a speaker associated with a television system.

10. The system of claim 6 wherein at least one of the processor and the memory are located remotely from the at least one media gateway appliance.

11. A method for generating an audible prompt in response to the actuation of a remote control in a system comprising:
at least one media gateway appliance, comprising at least one processor;
at least one memory; and
at least one wireless signal receiver, wherein the memory is adapted to store audio prompt data associated with at least one particular button upon a remote-control device; and
the method comprising the steps of:
receiving from the wireless signal receiver a signal indicative of the actuation of at least one button upon a remote-control device;
retrieving from the at least one memory audio prompt data associated with the at least one actuated button; and
generating an audio signal based, at least in part, on the retrieved audio prompt data.

12. The method of claim 11 wherein the media gateway appliance comprises at least one of the following:
a set-top box;
a television;
a computer;
a digital assistant;
smartphone; and
a tablet.

13. The method of claim 11 wherein the audio prompt data comprises at least one of the following:
a recording of speech;
a recording of a sound;
speech synthesis data; and
sound synthesis data.

14. The method of claim 11 wherein the generated audio signal drives a speaker associated with a television system.

15. The method of claim 11 wherein at least one of the processor and the memory are located remotely from the at least one media gateway appliance.

16. A method for generating an audible prompt in response to the actuation of a remote control in a system comprising:
at least one media gateway appliance, comprising at least one processor, at least one memory, and at least one wireless signal receiver, wherein the memory is adapted to store audio prompt data associated with at least one particular button upon a remote-control device; the process comprising the steps of:
receiving from the wireless signal receiver a first signal indicative of the partial actuation of at least one button upon a remote-control device;
retrieving from the at least one memory audio prompt data associated with the at least one partially actuated button;
generating an audio signal based, at least in part, on the retrieved audio prompt data;
receiving from the wireless signal receiver a second signal indicative of the full actuation of the at least one button upon a remote-control device;
retrieving from the at least one memory command data associated with the at least one fully-actuated button; and
executing the retrieved command data.

17. The method of claim 16 wherein the media gateway appliance comprises at least one of the following:
a set-top box;
a television;
a computer;
a digital assistant;
smartphone; and
a tablet.

18. The method of claim 16 wherein the audio prompt data comprises at least one of the following:
a recording of speech;
a recording of a sound;
speech synthesis data; and
sound synthesis data.

19. The method of claim 16 wherein the generated audio signal drives a speaker associated with a television system.

20. The method of claim 16 wherein at least one of the processor and the memory are located remotely from the at least one media gateway appliance.
